(19) United States
(12) Patent Application Publication
(10) Pub. No.: US 2012/0066032 A1
(43) Pub. Date: Mar. 15, 2012

(54) METHODS AND APPARATUS FOR INTEGRATING ELECTORAL DATA AND ELECTORAL INTERFACES

(76) Inventor: James H. Snider, Severna Park, MD (US)

(21) Appl. No.: 12/881,859

(22) Filed: Sep. 14, 2010

(51) Int. Cl. G07C 13/00; G06F 17/00

(52) U.S. Cl. 705/12

(57) ABSTRACT

Computer-implemented architectures and interfaces for providing a configurable electronic ballot for an election. Ballot interfaces that define a format for presenting ballot data to a voter are integrated with the ballot data using machine-readable metadata associated with the ballot data. Independent information agents may design ballot interfaces that incorporate sources of information that enable the voter to make less costly and better informed voting choices based on voter preferences. Decentralization of control over ballot interfaces reduces the election administrator's monopoly power over ballot information, thus creating a more robust voting information marketplace.

### BACKGROUND

Voting in elections is an integral part of modem democratic, corporate, and civic governance. Elections may be direct or indirect. In direct elections, policies such as initiatives, referendums, or corporate policies are voted on directly, whereas in indirect elections, representatives are selected who then formulate policy on behalf of the voters. Participation in elections by voters involves many tasks including among other things, registration and voting.

Voting in large-scale elections is often performed using ballots, which typically include two components: ballot data and a ballot interface. The ballot data include elements such as political jurisdiction, contested political office, political candidate name, political candidate party affiliation, and a blank to fill in a yes/no vote. The ballot interface includes the format with which that data is presented to the voter. Examples of format decisions are the order in which candidates are displayed; the size, style, and color of the font; and options to simplify the ballot such as straight-party voting. Straight-party voting entails voting once for a political party rather than voting separately for one or more political offices on the ballot.

### SUMMARY

Some embodiments are directed to using semantic information technology to separate ballot data from ballot interfaces while also allowing ballot data and interfaces to be seamlessly integrated. This combined separation and integration makes feasible more electoral options at lower information cost than conventional electoral systems provide. These electoral options include the creation of new types of ballot interfaces, new types of ballot data that would previously have imposed excessive voter information costs, and the integration of ballot interfaces with other types of voter electoral input, including voter registration and voter contributions to candidates and other electoral entities.

Some embodiments are directed to a method to seamlessly link ballot interfaces provided by independent information agents to ballot data controlled by an election administrator in such a way that voters need not manually rekey the vote choices generated through interaction with the information agent. With such a system, there may be less of a loss of efficiency in having the voter rather than the information agent send the information to the election administrator (“cast a vote”). This separation of the voter's preference generating from vote casting process means that the information agent cannot be sure how the voter actually voted, which may be an important value in many voting systems where vote buying is objectionable.

Voters often seek other sources of information in addition to the data available on a ballot. For example, the press, interest groups, and informal opinion leaders provide such information. Ballots may even include an option for the use of outside data, such as when they include a line for write-in candidates, political parties, or corporate directors. In accordance with some embodiments of the invention, independent information agents that design custom ballot interfaces may be provided with seamless access to election data including ballot data controlled by an election administrator. By providing additional information to voters in the election process, voters may be able to become better informed. The inventor has recognized and appreciated that to the extent that voters are sensitive to slight changes in the cost of acquiring electoral information, reducing the effort needed to link ballot data to ballot interfaces may increase the number of electoral options the voter is willing to consider.

Some embodiments of the present invention are directed to a method of providing a configurable electronic ballot for an election. The method comprises specifying a ballot interface that defines a format for presenting ballot data to a voter; sending, via at least one network, a request for the ballot data, wherein at least one datum in the ballot data is associated with at least one machine-readable tag that identifies a meaning of the at least one datum; receiving the ballot data in response to the request; and integrating the ballot data with the ballot interface based, at least in part, on the at least one machine-readable tag to generate the configurable electronic ballot for the election.

Some embodiments are directed to a computer-readable storage medium encoded with a plurality of instructions that, when executed by a computer, perform a method. The method comprises specifying a ballot interface that defines a format for presenting ballot data to a voter; sending, via at least one network, a request for the ballot data, wherein at least one datum in the ballot data is associated with at least one machine-readable tag that identifies a meaning of the at least one datum; receiving the ballot data in response to the request; and integrating the ballot data with the ballot interface based, at least in part, on the at least one machine-readable tag to generate the configurable electronic ballot for the election.

Some embodiments are directed to a computer system including a first computer and a second computer connected via at least one communication medium. The second computer comprises: at least one processor programmed to: specify a ballot interface that defines a format for presenting ballot data to a voter; send via at least one network, a request for the ballot data, wherein at least one datum in the ballot data is associated with at least one machine-readable tag that identifies a meaning of the at least one datum; receive the ballot data in response to the request; and integrate the ballot data with the ballot interface based, at least in part, on the at least one machine-readable tag to generate the configurable electronic ballot for the election.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of a conventional hierarchical ballot structure;

FIG. 2 is a schematic diagram of a hierarchical ballot structure used with some embodiments of the invention;

FIG. 3 is flowchart of a voting process using a customized ballot in accordance with some embodiments of the invention;

FIG. 4 is a flowchart of a voting process initiated through an election administrator in accordance with some embodiments of the invention;

FIG. 5 is a flowchart of a voting process initiated through an independent information agent in accordance with some embodiments of the invention;

FIG. 6 is a flowchart of a process for integrating ballot data with a ballot interface provided by an independent information agent in accordance with some embodiments of the invention;

FIG. 7 is an electoral chart that describes tasks that may be integrated in an electoral interface in accordance with some embodiments of the invention;

FIG. 8 is a display of an exemplary voter registration application that may be integrated in an electoral interface in accordance with some embodiments of the invention;

FIGS. 9 and 10 are displays of exemplary voter contribution forms that may be integrated in an electoral interface in accordance with some embodiments of the invention;

FIG. 11 is a display of an exemplary absentee registration form that may be integrated in an electoral interface in accordance with some embodiments of the invention;

FIG. 12 is a display of an exemplary write-in candidate application that may be integrated in an electoral interface in accordance with some embodiments of the invention;

FIG. 13 is a display of an exemplary referendum petition that may be integrated in an electoral interface in accordance with some embodiments of the invention;

FIGS. 14 and 15 are displays of exemplary voter complaint forms that may be integrated in an electoral interface in accordance with some embodiments of the invention;

FIG. 16 is a portion of an exemplary electronic ballot created in accordance with some embodiments of the invention;

FIG. 17 is a portion of an exemplary political ballot created in accordance with some embodiments of the invention;

FIG. 18 is a portion of an exemplary corporate ballot created in accordance with some embodiments of the invention;

FIG. 19 illustrates an exemplary computer system on which some embodiments of the invention may be implemented;

FIG. 20 illustrates an exemplary networked computer system having components that may be used by some embodiments of the invention to provide automated conflict of interest searching and/or reporting;

FIG. 21 illustrates a political ballot that may be created in accordance with a conventional electoral system; and

FIG. 22 illustrates a corporate ballot that may be created in accordance with a conventional electoral system.

### DETAILED DESCRIPTION

In many elections the same entity (e.g., an election administrator) controls the ballot data (e.g., which candidates are eligible to be shown on the ballot) and the ballot interface (e.g., the order in which candidates are listed on the ballot). Often the election administrator is directly or indirectly appointed by elected officials who have a self interest in using the ballot to erect barriers to political competition. For example, representatives of the major political parties may be given a privileged position on the ballot, and it may be made prohibitively costly for representatives of other political parties to secure access to the ballot. The self-evident conflict that election administrators have in designing ballots may also prevent them from integrating much useful information into a ballot interface, such as legislative records, candidate speeches, voter reviews, and press reviews.

Even when an election administrator has no conflict of interest in designing a ballot, the ballot interface may be biased. For example, candidates for a particular office listed first may be more likely to receive votes than those listed last, regardless of any other characteristics of the candidates. Similarly, voters may pay more attention to and vote on referendum items listed at the top of a ballot rather than items listed at the bottom of the ballot. When a non-vote is counted as equivalent to a no-vote (as is often done with referendums), items placed at the bottom of a ballot may be less likely to succeed.

Since a ballot interface is a type of free speech, centralized control of ballot interfaces may conflict with democratic values concerning the need for free and diverse sources of speech, especially speech not directly or indirectly controlled by elected officials. Courts and democratic theorists have often held that political speech is the type of speech that needs the greatest protections. One implication of this is that centralized control of ballot interfaces in democratic elections creates the greatest conflict with democratic values. However, technological limitations in conventional ballot systems have limited the application of such democratic values to ballot interfaces.

Similar reasoning applies to corporate elections. Being elected to serve on a corporate board is often considered highly desirable. Corporate directors are also fiduciaries for shareholders (or, for non-profit corporations, their members). Thus, corporate directors have an inherent conflict of interest when they design ballots for shareholders that affect their own chances of re-election. In conventional electoral systems, technological limitations have prevented the application of widely accepted corporate governance principles to ballot interfaces.

With the advent of online electronic voting, an election administrator may provide multiple ballot interfaces for voters, such as a ballot in the preferred language of the voter or with an extra large typeface for the visually impaired voter. Despite these improvements, countless other interfaces may be better suited for an individual voter. Accordingly, some embodiments of the invention relate to methods and apparatus for enabling a user to select a ballot interface independent of those provided by an election administrator.

Having election administrators place their ballots online offers many potential advantages. One such advantage is that it saves the voter from the extra time and inconvenience associated with traveling to a polling place, parking, waiting in line, and eventually voting. When the election is conducted during a workday, it may also mean taking time off from work.

Online voting also has the potential to facilitate the use of alternate ballot interfaces as described herein. Just as it is more convenient for consumers to comparison shop online than it is by visiting brick and mortar stores, it may be more convenient for voters to access multiple ballot interfaces online than offline. Online ballots also allow for the possibility of interactivity in a way not possible with physical ballots.

Although ballot data and a ballot interface are distinct ballot components, they may influence one another. In particular, the interfaces available for a particular set of ballot data may have a great impact on the types of data deemed feasible to include on a ballot. As a general rule, ballots involve a tradeoff between the benefits of voter accuracy and the costs of voter information acquisition. Accuracy involves the extent to which voter preferences are translated into votes. The closer voter preferences and votes are aligned, the greater the accuracy. One way to improve accuracy involves increasing the number of options available to voters. For example, as ballot access entry barriers are reduced for candidates and more candidates compete in an election, democratic theory suggests that the odds generally increase that one of those candidates will more accurately reflect a well-informed voter's preferences. But these added candidate options impose information costs on voters, which may make it prohibitively costly for voters to become well informed. That is, although more choices on a ballot may enable a voter to select a candidate that more closely reflects their values, including too many candidates may prevent voters from gaining a sufficient understanding of each candidate's platform to make an informed choice.

In conventional ballot systems, the integration of ballot data and interface often makes information costs so high that accuracy is given short shrift. Indeed, courts and political scientists have long sanctioned onerous limitations on potential candidates' access to ballots in the name of preventing “voter confusion.” For example, ballots that include dozens of candidates for a particular office are generally considered too complex for voters, as are preference voting systems in which voters rank order candidates rather than merely selecting yes or no votes. The inventor has recognized that if voters were given convenient access to voting interfaces that greatly reduced the costs of choosing among voting options, then more complex voting options would be feasible.

Voters often consult information agents such as press, interest groups, and informal opinion leaders about voting preferences that are not contained in the ballot interface provided by an election administrator. However, such independent information agents (i.e., agents other than the election administrator) typically do not have machine-readable access to the ballot data provided by election administrators. Accordingly, after a voter has consulted with one or more independent information agents regarding voter preferences, the voter is typically required to manually reenter their voting preferences into the ballot provided by the election administrator. As the number of election choices on the ballot increases, this manual reentry becomes a significant burden on the voter.

The inventor has recognized and appreciated that such burdens placed on voters in elections may be reduced by providing a flexible ballot system that seamlessly integrates ballot data and a ballot interface of the voter's choosing. To this end, some embodiments of the invention are directed to methods and apparatus for integrating ballot data provided by a centralized entity (e.g., an election administrator) with a ballot interface selected by a voter using a machine-readable schema or data structure (a “ballot ontology”) that associates the ballot data with the ballot interface. Although embodiments of the invention may be used in combination with any suitable data structure(s) designed to describe a ballot ontology, an exemplary ballot ontology for use with some embodiments of the invention is described in more detail below. As defined herein, an information agent may create a ballot interface for use with some embodiments of the invention. However, some information agents may not create a ballot interface, but rather may provide information that may be used with a ballot interface to enable a voter to become better informed.

The inventor has appreciated that the separation and seamless integration of ballot data and interfaces may be facilitated by using online, well-structured, self-documenting ballot data. Any suitable computer language for adding meaning to ballot data may be used to describe a ballot ontology for use with embodiments of the invention, although widespread adoption of a particular set of tags for assigning meaning to ballot data may increase the economies of scale of high quality applications that use ballot data to create ballot interfaces. Machine-readable ballot data refers to well-structured, self-documenting data that can be automatically read and exchanged between computers. The inventor has appreciated that semantic web technologies such as XBRL, rdf, microformats, and OWL make online, machine-to-machine data exchanges possible.

In an exemplary ballot ontology, individual tags (or metadata) may be used to describe ballot data, and the ballot ontology may include a set of linkages between the tags that constitute a ballot. Items of data on a ballot may be associated with metadata to enable the ballot data to be self-documenting for machine reuse. For example, a data item for “candidate name” may be associated with appropriate metadata so a computer accessing the data item online would know that the data item referred to a particular candidate.

Metadata associated with ballot data items may be related to each other so as to constitute the ballot ontology. For example, ballots are typically hierarchically structured, so the associated ballot metadata may also be hierarchically structured. An exemplary ballot hierarchy may include a government entity administering the election at a top level, a list of offices up for election at a middle level, and a list of candidates at a lower level.

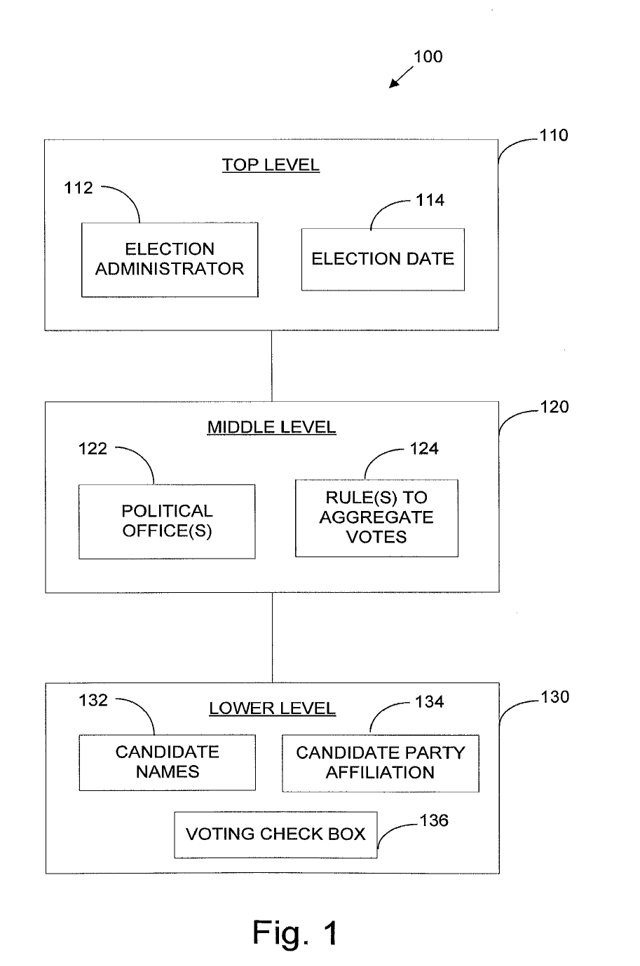

A conventional hierarchical ballot structure for a ballot for political candidates seeking election under a single member, plurality (also called “first-past-the-post”) voting rule is illustrated in FIG. 1. Ballot structure 100 includes top level 110, middle level 120, and lower level 130. Top level 110 includes administrative data items related to the election including an election administrator 112, such as a government entity administering the election (e.g., Anne Arundel County, Maryland) and an election date (e.g., Nov. 2, 2010). Middle level 120 includes procedural data items related to the election including information about political office(s) 122 contested during the election (e.g., county executive), and rule(s) 124 used to aggregate votes in the election (e.g., first-past-the-post). It should be appreciated that some data items in middle level 120 such as political office(s) 122 may be explicit on the ballot, other data items such as rule(s) 124 to aggregate votes may not be explicit on the ballot. Rather, rule(s) 124 may be implied on the ballot by a “yes” vote and the rule(s) 124 may be explicitly defined elsewhere based on relevant codes or laws.

Lower level 130 includes voting data items that specify information to enable a voter to choose a candidate for a contested political office. Voting data may include candidate names 132 (e.g., John Smith), candidate party affiliation 134 (e.g., Democratic Party), and a voting check box 136 that enables the voter to vote “yes” for one of the candidates listed on the ballot.

In ballot structure 100, an election administrator has prefilled most of the ballot data but has left the voter to fill in the check box to vote “yes.” A ballot ontology limited to describing this type of political candidate election is inflexible because there are many electoral contexts that such a ballot ontology would not cover. For example, election entities may be for-profit corporations, non-profit corporations, and civic groups rather than governments. Additionally, votes may be cast for political parties, issues, or directors of public companies rather than simply political candidates. Furthermore, votes may be aggregated according to many different formulas, such as simple plurality voting, plurality runoff voting, sequential runoff voting, borda count voting, condorcet voting, approval voting, and instant runoff voting—each with many possible variations in the specific formula for translating votes into seats. Straight-party voting, candidate write-in names, and other ballot options, including options that have not yet been imagined or implemented, may also be desired. Exemplary ballots produced using a conventional ballot interface controlled by a central administrator are illustrated in FIGS.

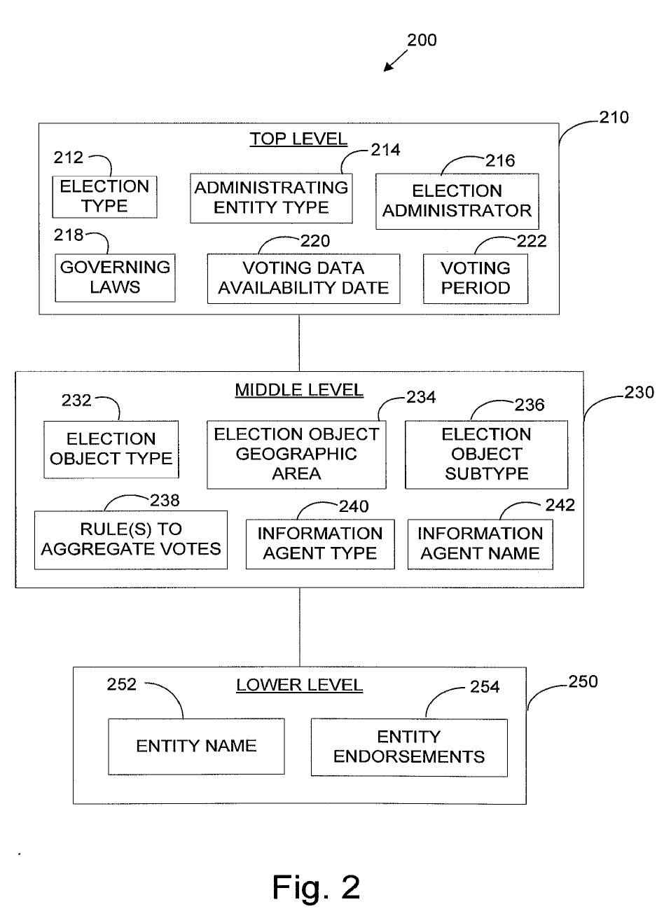

The inventor has recognized that capturing the vast array of ballot options may require a more universal, flexible ontology. A more universal and flexible ontology may also allow for greater economies of scale in the market for ballot interface applications. An exemplary ballot ontology for use with some embodiments of the invention is illustrated in FIG. 2.

Ballot ontology 200 includes top level 210, middle level 230, and lower level 250. Each of these levels of the hierarchy may contain one or more data items that when considered together constitute a ballot. Top level 210 may include administrative data items such as election type 210. For example, the election type 210 may be either a final (general) election or a preliminary (primary or nominating) election. Other data items in top level 210 may include administrating entity type 214 (e.g., government, for-profit corporation, non-profit corporation), election administrator 216 (e.g., Anne Arundel County, Maryland, IBM, Common Cause), and laws governing the election 218 (e.g., Congressional statute, U.S. Securities & Exchange Commission regulation, U.S. Federal Election Commission regulations). The administrative information in top level 210 may also include data items related to the voting data such as a voting data availability date 220 (e.g., data political candidates register for office) and a voting period 222 including a date when voting begins (e.g., any date between candidate registration and the date voting ends) and a date voting ends. The administrative data items shown in ballot ontology 200 are merely exemplary and other administrative information may also be included in top level 210, if desired.

Middle level 230 includes data items such as election object type 232 (e.g., political candidate, corporate director, initiative, referendum), election object geographic area 234 (e.g., international, national state, city), and election object subtype 236 (e.g., president, governor, mayor). Middle level 230 may also include procedural information such as rule(s) or formula (s) 238 to aggregate votes (e.g., single transferable vote, including a formal model). Data items relating to information agents may also be included in middle level 230. For example, information agent type 240 (e.g., political party, interest group, news outlet, and information agent name 242 (e.g., Republican party, Democratic Party, Green Party) may also be included in middle level 230. It should be appreciated that other data items may also be included in middle level 230, if desired.

Lower level 250 includes data items such as entity name 252 (e.g., name of political candidate, political party, or initiative). Ballot interfaces in political elections are usually structured around the endorsements of one type of information agent: political parties. For corporate ballots, the recommendations of a corporate nominating committee may serve a similar role. Accordingly, lower level 250 may also include entity endorsements 254 (e.g., political party) to indicate to the voter endorsements for particular entities on the ballot.

The same metadata may exist at different levels of the hierarchy of a ballot ontology. For example, each political office or subset of offices based on political jurisdiction (e.g., national, state, and local offices) may have different dates on which early voting may begin. Similarly, different laws may relate to different electoral objects on the ballot.

Another type of ballot metadata that may be included as a portion of a ballot ontology is a link. Ballot data items may include one or more links to objects to which they refer. For example, a candidate's name may link to a candidate's website, a candidate's political district may link to a map of that district, and the name of the entity administering the election may link to that entity. More than one link may be associated with a data item via a user configurable technique such as clicking on a footnote mark, right clicking on the data object, double clicking on the data object, or using any other suitable technique.

Once ballot data items are conceptualized in more universal, flexible terms, many new ballot interfaces become feasible. One example is the role of information agents on ballots, insofar as information agents may provide information to voters regarding voting preferences and recommendations. Placing the recommendations of information agents on ballots may be beneficial in many political and other elections because voters have minimal incentive to gather exhaustive information about ballot options. By relying on the recommendations of information agents, voters may be able to significantly reduce their information costs. An extreme but inflexible example of voting based on recommendations of information agents is a straight-party vote in which a voter votes for all candidates of a particular political party.

Although the use of recommendations provided by information agents facilitates voter access to information for making an informed choice, most if not all current ballots designed by election administrators minimize the use of such recommendations. For political elections, the limit is usually one recommendation per candidate (i.e., the candidate's political party). Moreover, the choice among political parties is often limited to the Democratic and Republican parties. Third parties may be offered ballot access, but the high cost they must incur to get on the ballot is a barrier that may result in few or no third parties actually getting on the ballot.

The types of endorsements offered by information agents are also highly limited, such as “support” or “not support.” Rank ordering or otherwise expressing more subtle preferences is usually not allowed on a ballot.

The type of information agents allowed on a ballot is also highly restricted. Political parties, for example, are only one type of information agent. Endorsements by other types of information agents, such as traditional media outlets, are usually excluded from ballots altogether, as are new types of media outlets that provide interactive endorsements based on a voter's preferences.

In addition to facilitating the integration of centrally-controlled ballot data new and flexible ballot interfaces, a ballot ontology may also be useful in facilitating the transfer of information between information agents. For example, an independent information agent may create a ballot interface and the functionality of the ballot interface may be extended by another information agent who is linked to the ballot interface. Accordingly, an extensible ballot interface may be created that is a composite creation of a plurality of information agents.

Centralized control of ballot interfaces has led to a dearth of creativity in ballot interface design. For example, although the U.S. has more than 13,000 local electoral bodies in charge of ballot interface design, each one has a monopoly on ballot interface design with little incentive to innovate. As with many other types of Internet-based applications, the choice of an interface can now be given to the user; in this case, the voter casting a ballot or an information agent selected by the voter. Accordingly, some embodiments of the invention are directed to decentralizing control of ballot interfaces by enabling voters to take control of the ballot interface from an election administrator and delegate it to a trusted information agent without necessarily, as in proxy voting, having the information agent actually cast the vote. Creative ballot design may reduce voter information costs to such an extent that it becomes feasible for voters to choose from among hundreds or thousands of candidates and even rank order their preferences—all with no more effort on the voter's part than is required by conventional ballots with short candidate lists and simple “yes” and “no” voting for candidates.

With conventional ballots, an official election administrator provides both the ballot data and interface for the data. The inventor has recognized that machine-readable tags, embodied in a ballot ontology, as described above, may be used to separate and then seamlessly integrate ballot data and ballot interface. By decentralizing control over ballot data and ballot interfaces, independent information agents may be allowed to create the interface, while control over the ballot data remains with an election administrator. The use of such agents may fundamentally change the economics of ballots, reducing barriers to ballot access, complex voting systems, and integration with other parts of the election system.

In a conventional balloting procedure an election administrator prepares ballot data and a ballot interface. A voter may provide information to the election administrator authenticating his or her identity. After authentication, the voter is able to access the ballot and vote.

Some embodiments of the invention are directed to a novel voting procedure in which a voter receives ballot data from the authorized election administrator and uses an independent information agent (i.e., an information agent other than the election administrator) to format the data, help make voting choices, fill in the blanks, and transfer the resulting data to the voter, who then submits the data to the election administrator.

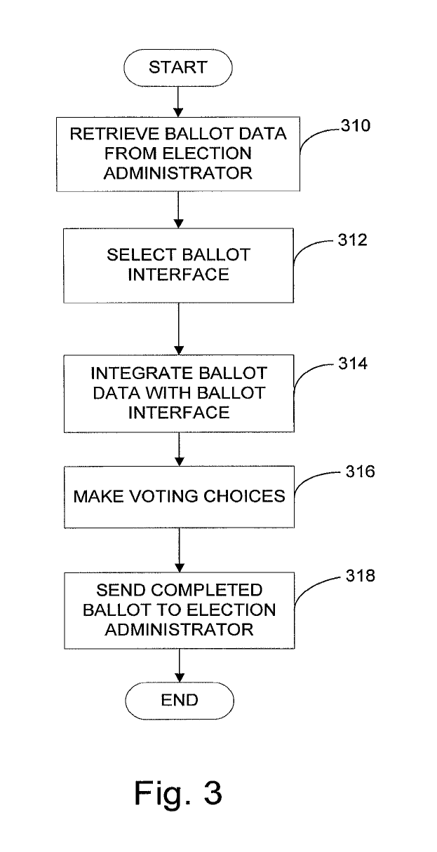

A balloting process in accordance with some embodiments of the invention is illustrated in FIG. 3. In act 310, ballot data is retrieved from an election administrator. Retrieval of the ballot data may be accomplished in any suitable way, as embodiments of the invention are not limited in this respect. For example, the election administrator may prepare and post the ballot data online, thereby making it available for download for integration with a ballot interface. In act 312, a voter selects a ballot interface that may be used to format the received ballot data. In act 314, the received ballot data and the selected ballot interface are integrated to produce a ballot. For example, the ballot may be presented to a voter via a user interface displayed on the voter's computer. The ballot may include one or more recommended voting choices provided by an information agent as described in more detail below. In act 316, the voter may interact with the ballot to make one or more voting choices. In some embodiments, voting choices may be pre-selected on the customized ballot based, at least in part, on a particular information agent associated with the ballot interface that was selected in act 312. However, in other embodiments, voting choices may not be pre-selected, as aspects of the invention are not limited in this respect.

After the ballot has been completed, in act 318, the voter may send the completed ballot to an election administrator for processing. The ballot may be sent to the election administrator in any suitable manner including, but not limited to, electronically transmitting the completed ballot to a secure computer hosted by the election administrator, uploading the completed ballot to a secure website of the election administrator, and printing the completed ballot and delivering the completed ballot to the election administrator (e.g., by mail, by delivering the ballot to a polling station, etc.).

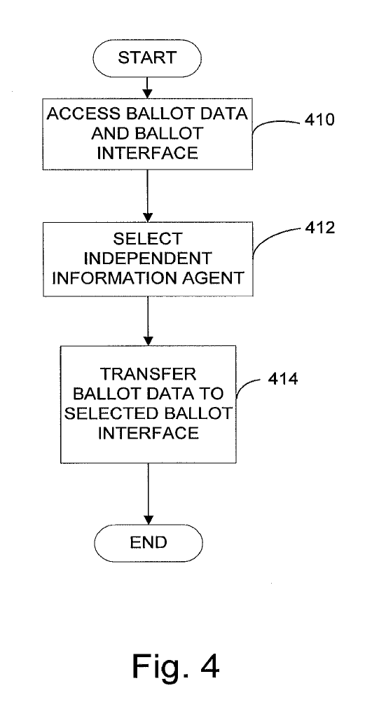

One implementation of a balloting process in accordance with some embodiments of the invention is illustrated in FIG. 4. In act 410, a voter accesses ballot data and a ballot interface prepared by an election administrator. This may be accomplished, for example, by the voter interaction with a browser on a computer to navigate to a website set up by the election administrator. The website may display the ballot interface and in act 412, the voter may select an independent information agent to provide an alternate ballot interface. In response to selecting an independent information agent, an associated alternate ballot interface, established by the independent information agent, may be displayed to the user. For example, after selecting an independent information agent, the voter's browser may navigate to a website of the selected independent information agent that displays the alternate ballot interface for the independent information agent. In act 414, the ballot data prepared by the election administrator is automatically transferred to the alternate ballot interface to produce an alternate ballot. The voter may then interact with the alternate ballot as if it were created by the election administrator, to select voting choices as described above.

In this implementation, the voter initially relies on a default interface prepared by an election administrator. Some voters may prefer this implementation because of, among other things, tradition and convenience, as voters may find it convenient to navigate to one place to obtain both their ballot data and interface.

Governments have traditionally played a significant role in vetting information agents and other fiduciaries for voters. Political candidates and political parties, for example, often must disclose to voters substantial information about their financing. Political candidates may also be barred from certain conflicts of interest, such as serving in both the executive and legislative branches of government. As governments open ballots to additional information agents, they may provide some fiduciary vetting regarding information agents. Like political candidates who must disclose their finances before they are allowed on the ballot, only information agents willing to undergo some vetting could get on the election administrator's ballot interface. If the voter trusts this vetting process, the voter may prefer to initiate the voting process using the election administrator's ballot interface.

Some information agents may specialize in reviewing other information agents. Voters may want to know that in making those recommendations the higher level information agents do not have any conflicts of interest, such as kickbacks, referral fees, or ownership interests, with the lower level information agents. The aforementioned vetting process of information agents may be used to provide the voter with information regarding such potential conflicts of interest about the higher level information agents.

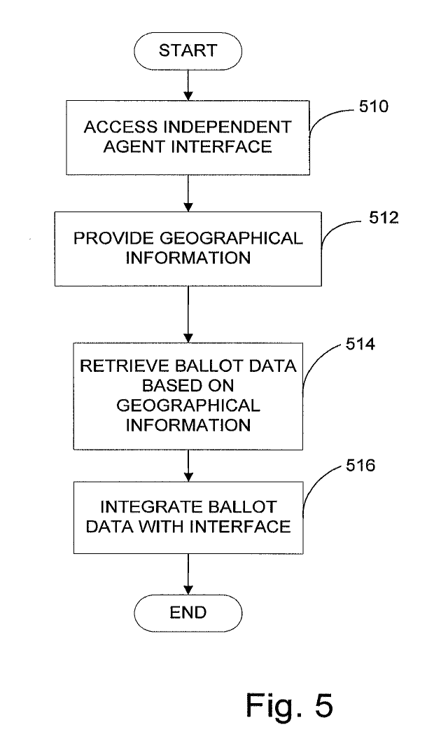

Another implementation of a balloting process in accordance with some embodiments of the invention is illustrated in FIG. 5. In this implementation, a voter may directly access an independent information agent's ballot interface. In act 510, a voter accesses an independent information agent's interface by, for example, directing a browser on the voter's computer to navigate to a website of the information agent that provides a particular ballot interface. The voter may interact with the ballot interface directly through the information agent's website or the voter may download the ballot interface from the website, as aspects of the invention are not limited in this respect. Some information agents may provide ballot interfaces for more than one geographical region. In act 512, the voter may interact with the information agent's website to provide geographical information (e.g., city, state, country, etc) to enable the information agent to determine the appropriate ballot data to retrieve for integration with the ballot interface. In act 514, ballot data prepared by an election administrator and posted online is retrieved based, at least in part, on the geographical information provided by the voter. The ballot data may be retrieved using any suitable technique including, but not limited to, using a file transfer protocol, or other secure method of transferring data over a network such as the Internet. In act 516, the ballot data retrieved from the election administrator is integrated with the ballot interface of the information agent to produce a ballot formatted in accordance with the ballot interface. The voter may then interact with the ballot to provide voting choices, as described in more detail below. After the ballot has been completed, the completed ballot may be transmitted to an election administrator to complete the voting process.

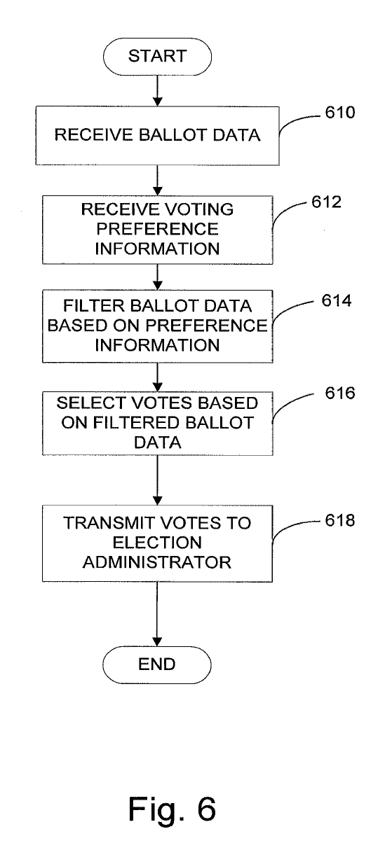

After a ballot has been created using either of the implementations above (or any other suitable implementation), the voter may interact with the customized ballot to make informed voting decisions facilitated by information included on the ballot provided by the ballot interface of the selected information agent. An exemplary process for integration of ballot data and a ballot interface provided by an independent information agent and a subsequent voting process is illustrated in FIG. 6. In act 610, ballot data is received from an election administrator. For example, after a voter accesses a website of an independent information agent, a request for ballot data may be transmitted using one or more networks to a location where the election administrator has posted the ballot data online. In response, the requested ballot data may be received by one or more computers associated with the independent information agent and the integration of the ballot data with the ballot interface may commence.

In some embodiments, the voter may have one or more interface settings that are stored by an independent information agent. For example, if the voter has used the information agent to provide a ballot for voting in a previous election, the interface settings used by the voter in the previous election may be stored by the information agent to facilitate the configuration of a ballot interface for future elections. In act 612, the voting preference information (including the interface settings, if applicable) for a voter is retrieved and in act 614, the voting preference information is used to facilitate the integration of the ballot data with the ballot interface to produce a ballot that is tailored to the voter's preferences. For example, the ballot data received by the information agent may be linked to other relevant data including, but not limited to, other websites that may help the voter make informed voting choices. Having the ballot data associated with metadata in a ballot ontology as described above may facilitate the integration of the ballot data with a ballot interface provided by an independent information agent. Exemplary ballot interfaces in accordance with some embodiments of the invention are discussed in more detail below, however it should be appreciated that any suitable ballot interface used to format ballot data may be used, as aspects of the invention are not limited in this respect.

After a ballot has been created based, at least in part on the received ballot data, the ballot interface provided by the information agent, and the voter's preferences, the voter may interact with the ballot to filter and sort the voting options using information provided by the information agent. For example, the voter may iteratively work with the agent to gather information, express preferences, and receive recommendations for voting in the election. The type of filtering services offered by information agents may be highly varied and include such variables as political party affiliation, candidate education credentials, candidate experience in public life, legislative voting record, legislative influence on peers, legislative public policy creativity, legislative oversight record, constituent reviews, interest group reviews, and press reviews.

Unlike current top-down recommendations offered by political parties, interest groups, and mass media, the recommendations provided by an information may be interactive. That is, voters may express their preferences and then information agents may rank or otherwise make recommendations to voters based on those preferences. If rank ordered, the recommendations may be transferred to rank ordered ballots. Although many political scientists favor rank ordered voting systems because of their more accurate translation of voter preferences into candidate seats, adoption of rank ordered voting systems has been generally inhibited by the extra and usually intollerable information gathering burden such voting places on voters. To the extent that a voter's rank ordering is automatic and can easily be transferred to ballot data, it becomes a much more practical form of voting.

In act 616, the information agent selects voting choices on behalf of the voter based on the aforementioned iterative process with the voter. The information agent then sends the voter's votes and any other ballot input needed to fill in the ballot data.

After reviewing the selected voting choices, in act 618, the votes may be transmitted to an election administrator to complete the voting process. For example, the voter may connect to the election administrator by logging into a secure website for voting in the election. The voter may then provide authentication information to authenticate the voter's identity prior to providing the voting information. After authentication, the voting choices prepared with help from an information agent may be automatically transferred to the election administrator without requiring manual reentry of the votes by the voter. As with some current absentee and online voting rules, a guard against voters' selling their votes to candidates or acting impulsively is the right to change their vote at any time before the polls close. Thus, the voting sequence above may be repeated many times prior to the end of an election.

In some embodiments ballot data and ballot interfaces may be integrated with other electoral interfaces built upon a full set of electoral data. For example, ballot data may be integrated with other government electoral data such as voter registration, campaign finance disclosure, gift disclosure, and lobbying disclosure. Some or all of this information may be integrated into an independent information agent's ballot interface. For example, a ballot interface may start by registering the voter, then allow the voter to vote. If same day voter registration is allowed, all of these processes may occur during a single voting session. In such embodiments, a ballot ontology as described above may be considered as a subset of an electoral ontology geared to voters, and a ballot interface may be considered as a subset of a general purpose electoral interface.

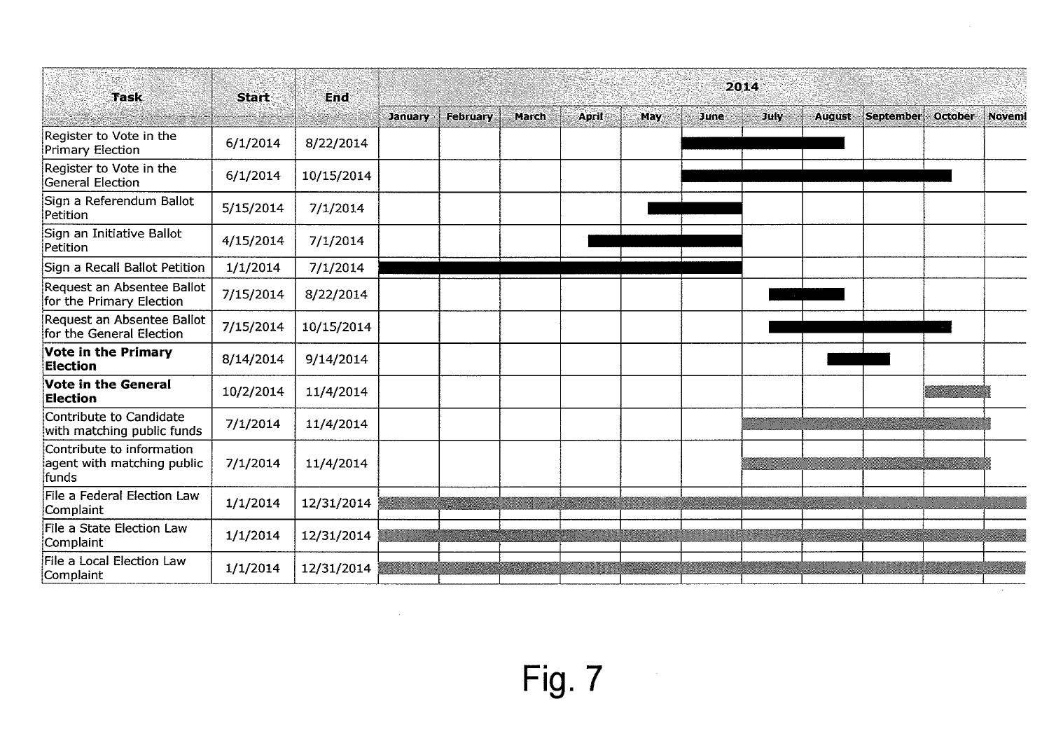

An election administrator may assign voters many tasks as part of the electoral process. In accordance with some embodiments, the voter may interact with an electoral interface to complete one or more of these assigned tasks. FIG. 7 displays an exemplary chart that includes dates for electoral tasks to be completed by a voter. Tasks that directly relate to voting in an election are indicated in bold. It should be appreciated however, that many other types of charts and/or interfaces may be used to list various tasks and associated documents that voters may be asked to fill out as part of an election cycle and the Gant chart displayed in FIG. 7 is merely one example of such a chart.

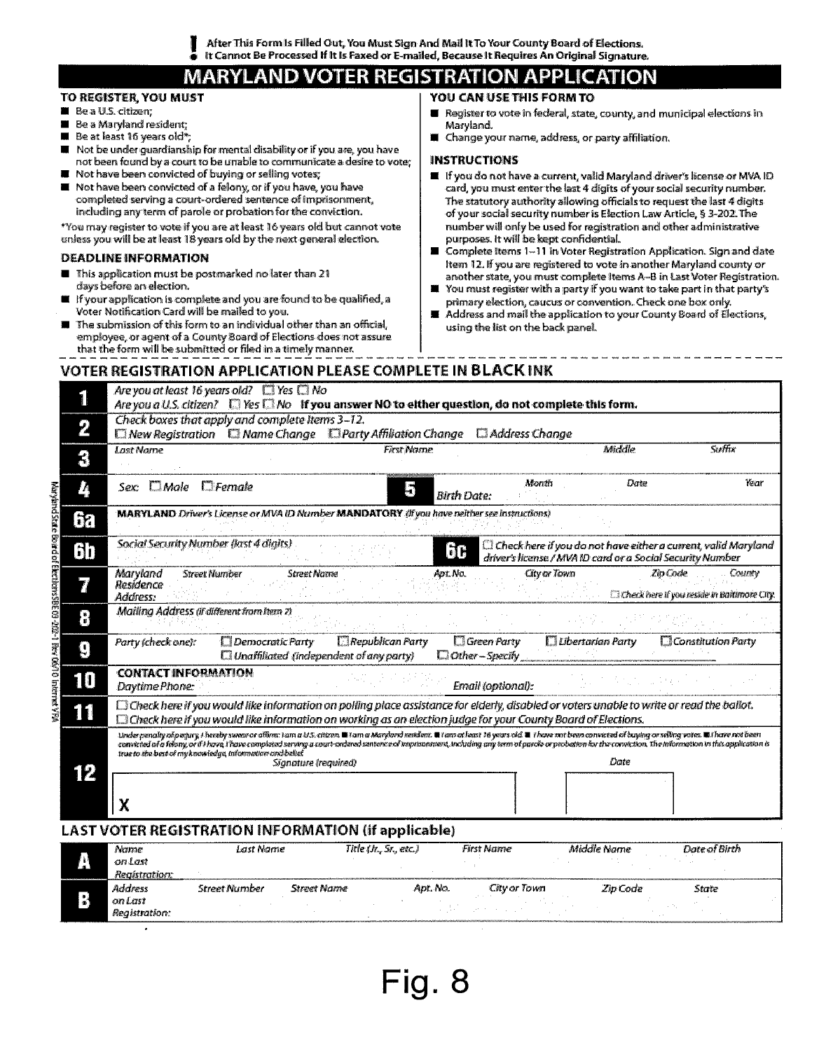

Exemplary types of forms/applications that may be integrated into a single interface or application are illustrated in FIGS. 8-15. However, it should be appreciated that other types of forms or applications not explicitly displayed herein may also be integrated in accordance with embodiments of the invention. Prior to voting in an election, voters are typically required to register to vote. FIG. 8 displays an exemplary voter registration application that a user may fill out to register. Such voter registration forms typically include demographic information about the voter to enable an election administrator to verify the identity of the voter and ensure that the voter is only afforded a single vote in the election.

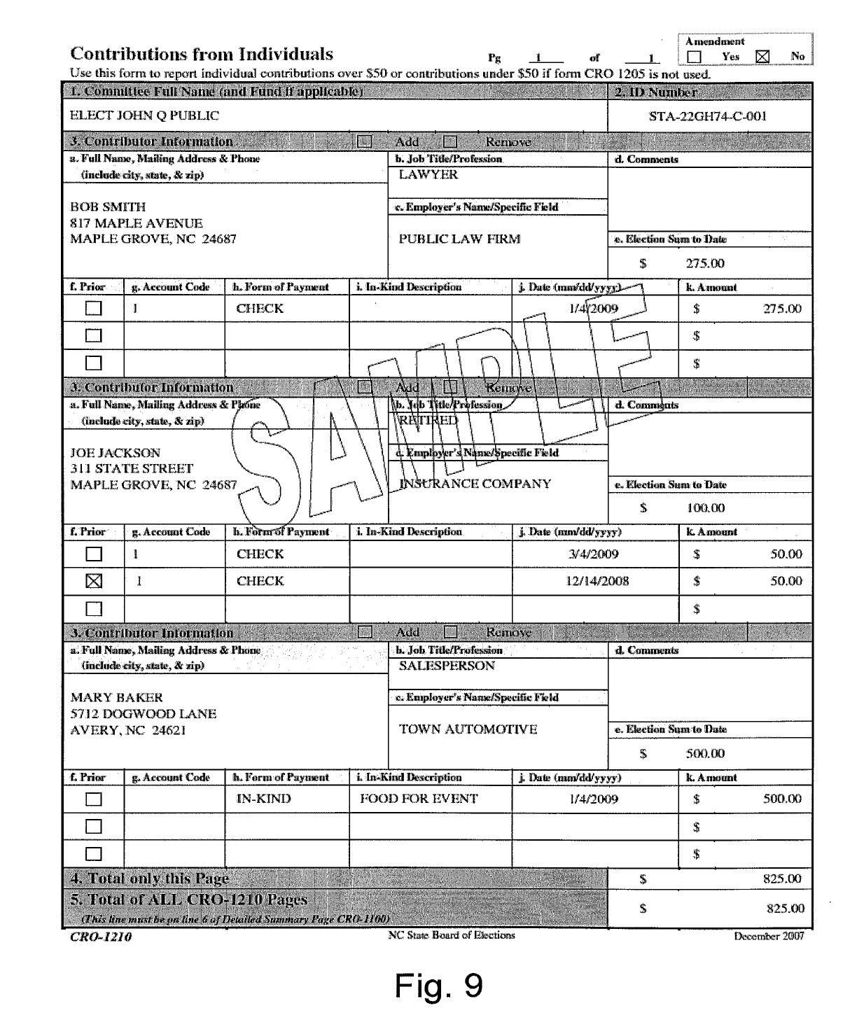

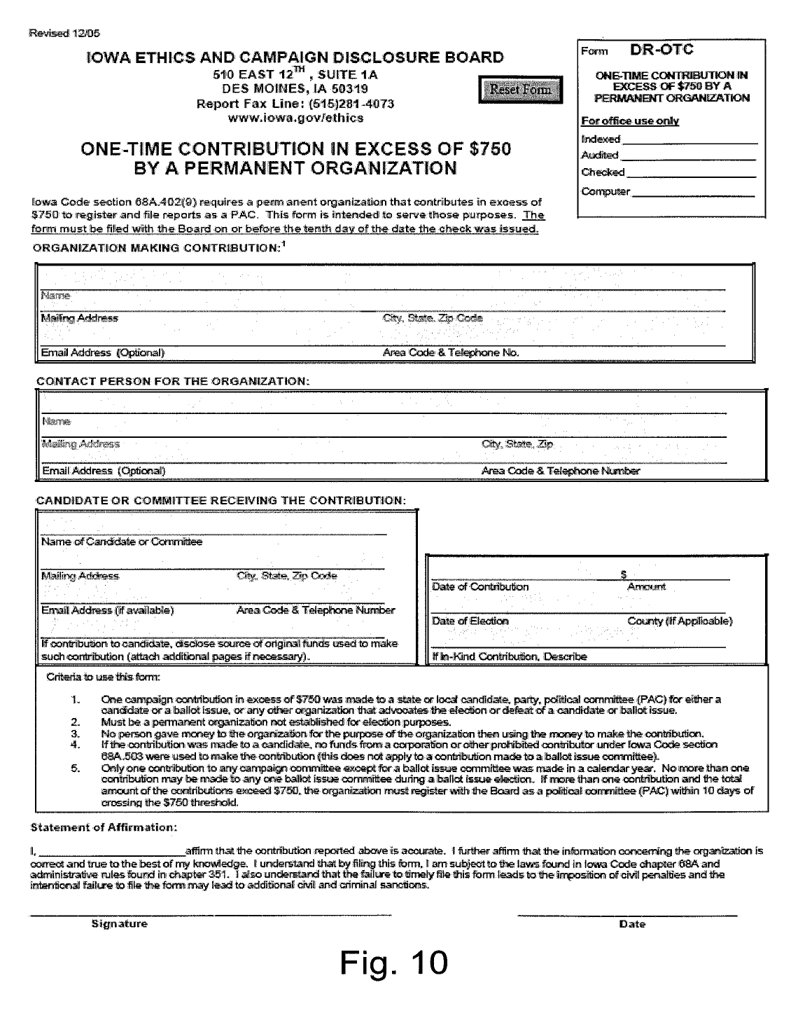

FIGS. 9 and 10 illustrate exemplary contribution forms for making a financial contribution to an individual or organization. Such forms contain identifying information for each contributor, information related to the purpose of the contribution, as well as information that may be used to facilitate conflict-of-interest reporting and public financing of elections.

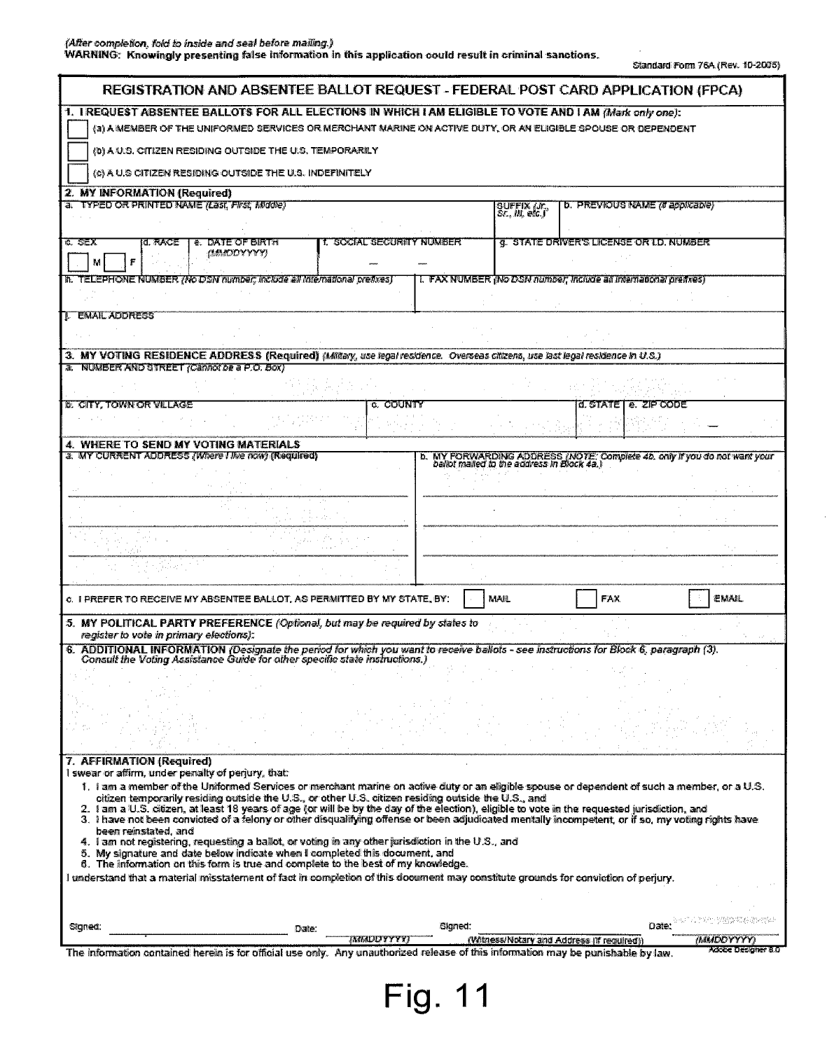

Some potential voters may prefer to vote by mail rather than in person at a polling station. Such voters may be eligible to vote in the election via an absentee ballot. FIG. 11 displays an exemplary registration and absentee ballot request to vote in an election. In addition to identifying information for the voter, such forms also typically include information related to where to send voting materials.

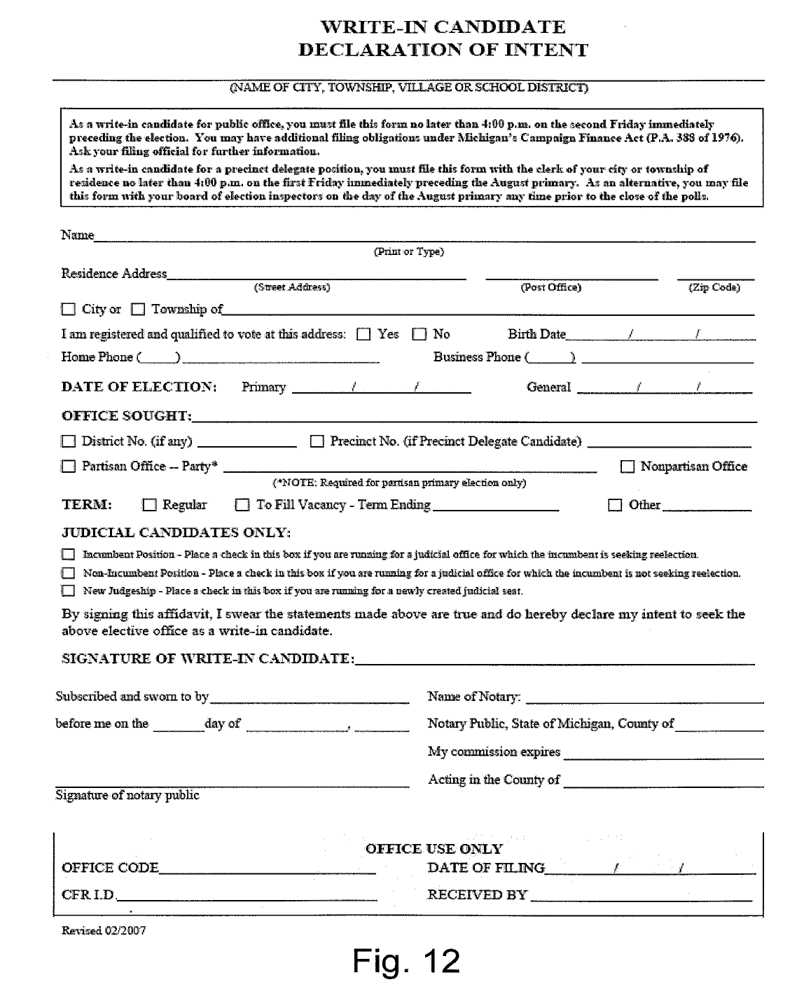

Some elections may allow voters to vote for write-in candidates provided that the write-in candidate has filed appropriate documentation with an election administrator. FIG. 12 displays an exemplary write-in candidate application for a potential write-in candidate. When independent information agents are seamlessly connected to ballot data and develop large followings for their good electoral databases and judgment, as embedded in their ballot interfaces, the write-in portion of ballots may become a realistic alternative to the portion heavily regulated by the election administrator. Although eligible write-in candidates may still need to disclose the same information as other candidates, candidate disclosure is a far lower burden to ballot access than current requirements to get one's name printed or otherwise listed on an election administrator's ballot, which may include following arcane regulations to design a petition, recruiting signature gatherers, gathering valid signatures, and then, as is often the case, fending off legal challenges by opposition interests who are able to find invalid signatures and other violations of ballot access laws.

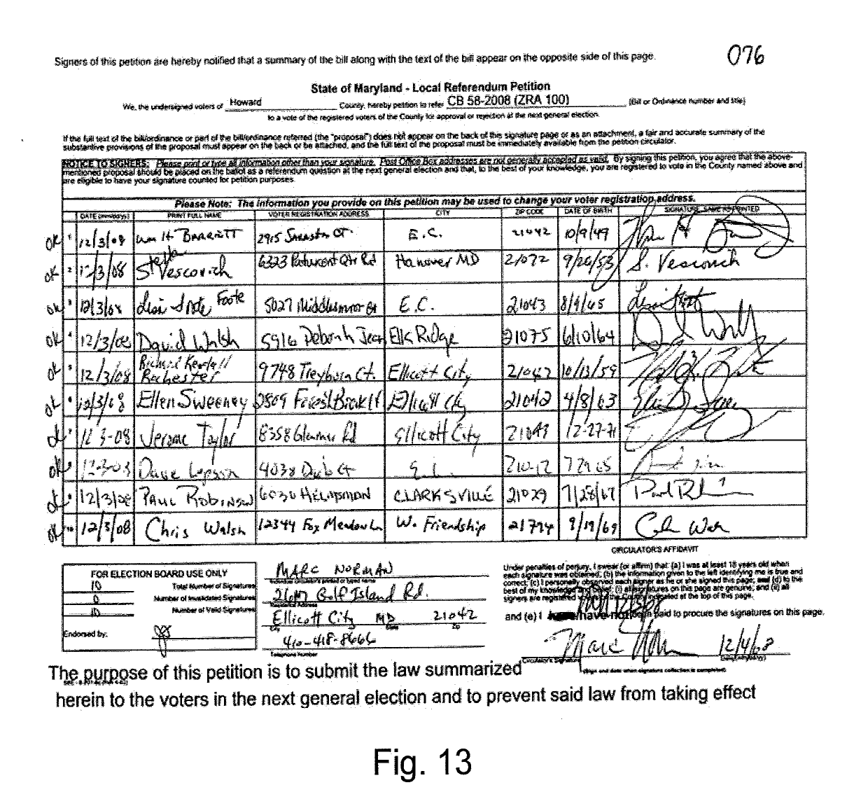

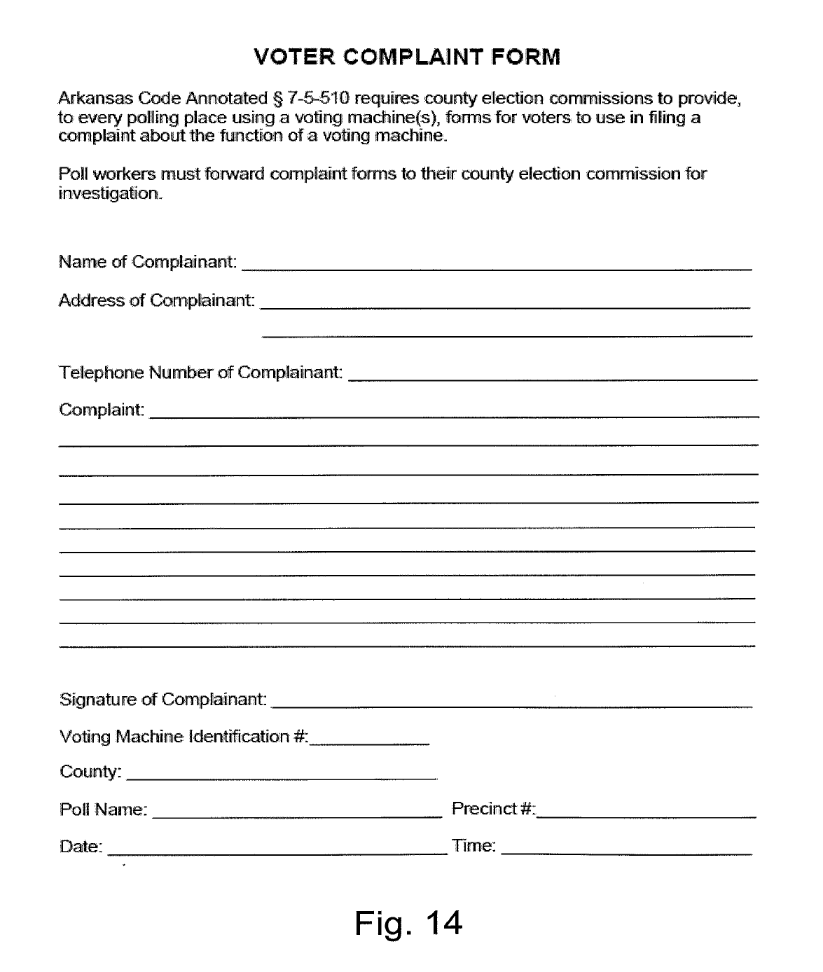

In some elections, initiatives or referenda may be placed on a ballot for consideration by the voting public. To limit the number of such items being included on ballots, an election administrator may require that a petition be filed with the election administrator in support of including the item on the ballot. An exemplary petition for a referendum is displayed in FIG. 13. Petitions such as the one illustrated in FIG. 14 may be integrated with other forms to enable voters who sign such petitions to automatically enter voting information including, but not limited to the voter's registration address.

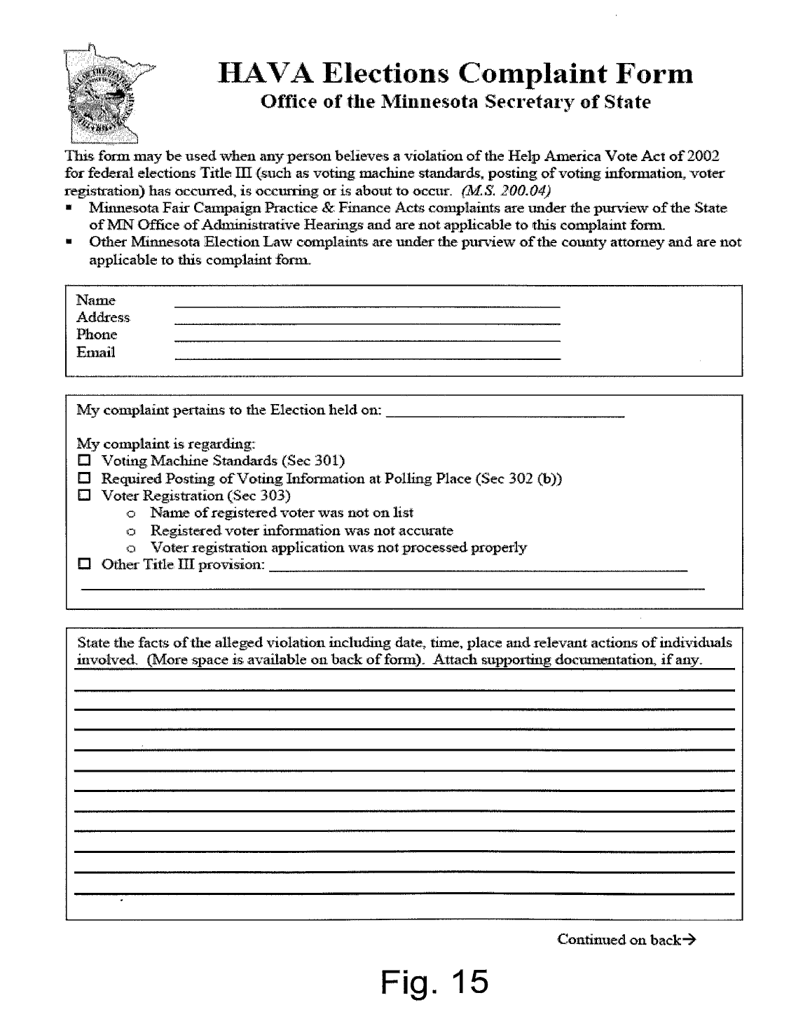

A principal component of political elections is that such elections provide equal access to all voters who have properly registered. One aspect of this access includes ensuring that there is a proper mechanism for filing complaints regarding voting machines that are not functioning properly or improper voting procedures at particular polling locations. FIGS. 14 and 15 display exemplary voter complaint forms that may be provided by an election administrator to file such complaints. In addition to include information identifying the voter that is registering a complaint, such forms often include information identifying a particular polling place and/or voting machine identifier.

The inventor has recognized and appreciated that the integration of electoral data from one or more of forms/applications displayed in FIGS. 8-15 (or any other type of election form) into a single interface or application may provide efficiencies not currently realizable with existing election systems. For example, integration of such forms may not require voters to provide redundant data entry. As should be appreciated from the forms displayed in FIGS. 8-15, much of the data entered on different types of election forms is redundant. For example, a legally required voter registration address is typically the same for all of the forms/applications. By integrating the various forms, the voter may only be required to enter this address once.

Additionally, when voters have to enter the same data multiple times, they often make mistakes. For example, petitions such as the petition illustrated in FIG. 13 sometimes require that voters enter their name exactly as it was entered on the voter's registration form, even if that form was signed decades ago and the voter doesn't remember how it was signed. The result is that many petition signatures are often needlessly disqualified. For example, the same individual who is registered as John P. Smith may have his petition disqualified if the registration says John Paul Smith. By integrating a voter's name (and other data) across forms, such problems may be at least partially mitigated.

Context sensitive integration may reduce the burden on voters to both learn about and fill out appropriate forms for particular electoral actions. For example, consider a voter who wants to contribute to a candidate during a primary election or during early voting in a general election. In an integrated electoral system, the voter may be able to right-click on or otherwise select the candidate's name and see a campaign contribution form as one of the resulting options, and then click on it. The contribution form may then automatically be filled out by the integrated system to include the voter's address, the candidate's name, and/or other information stored by the integrated system. In some instances, the only information required for a voter to enter into a contribution form may be a dollar amount for the contribution. After verifying the information in the form, the contribution data may automatically transmitted to the relevant parties, including the bank of the voter and the central election administrator. Because the contribution form is filled out in context, the voter may also assured that the appropriate form has been filled out in accordance with applicable laws.

As discussed above, seamless electoral interfaces may make it easier for the voter to submit electoral data to the election administrator electronically. This, in turn, should speed up data entry and access while reducing the election administrator's data entry costs and mistakes due to the unreliability of rekeying voter data.

A novel application for some embodiments of the invention concerns public financing of electoral information. Voters may be allowed to make contributions to candidates or political parties directly through a single ballot interface. This principle could also be extended to contributions to independent information agents on the ballot. If there is public financing, whereby voter contributions are matched in some ratio by government contributions, this could be integrated into the ballot interface rather than relying on a separate interface which voters must locate and then use to reenter their personal identifying information. Alternatively, governments may grant voters vouchers which they then allocate among certified ballot options, including candidates and information agents. In conventional public financing systems, voters typically write checks to candidates or political parties and the government tracks those filings via the reports of those entities. However, these reports are often filed months after the contributions, are often incomplete or otherwise inaccurate, and are often not corrected until after an election when they are useless. Having voters rather than candidates or political parties enter the contribution data provides a check on the reports filed by those entities and ensures timely public access to public financing information.

In many conventional electoral systems, much electoral data, such as campaign contributions, may be gathered by candidates and then submitted to an election administrator in aggregate form. This multistep reporting process slows down the rate at which this data be used for democratic accountability. Candidates also often have a conflict of interest in reporting contributor data in a timely and accurate way. One reason for putting the candidate in this reporting role is that it has been assumed to be too burdensome on small contributors to both make a contribution and do all the paperwork to submit it to an election administrator. A seamless electoral interface in accordance with some embodiments of the invention disclosed herein may result in making a contribution being no more difficult for the voter than both making the contribution and reporting it. In turn, candidates may be provided with faster access to matching funds while the public also benefits from more democratic accountability.

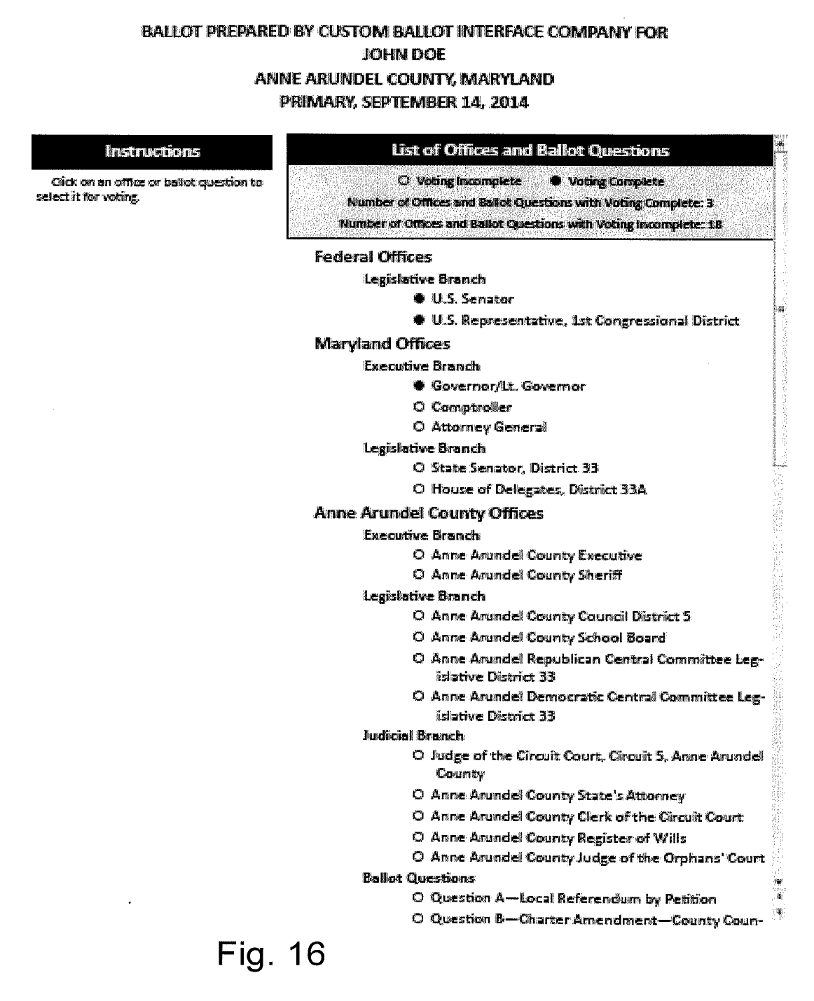

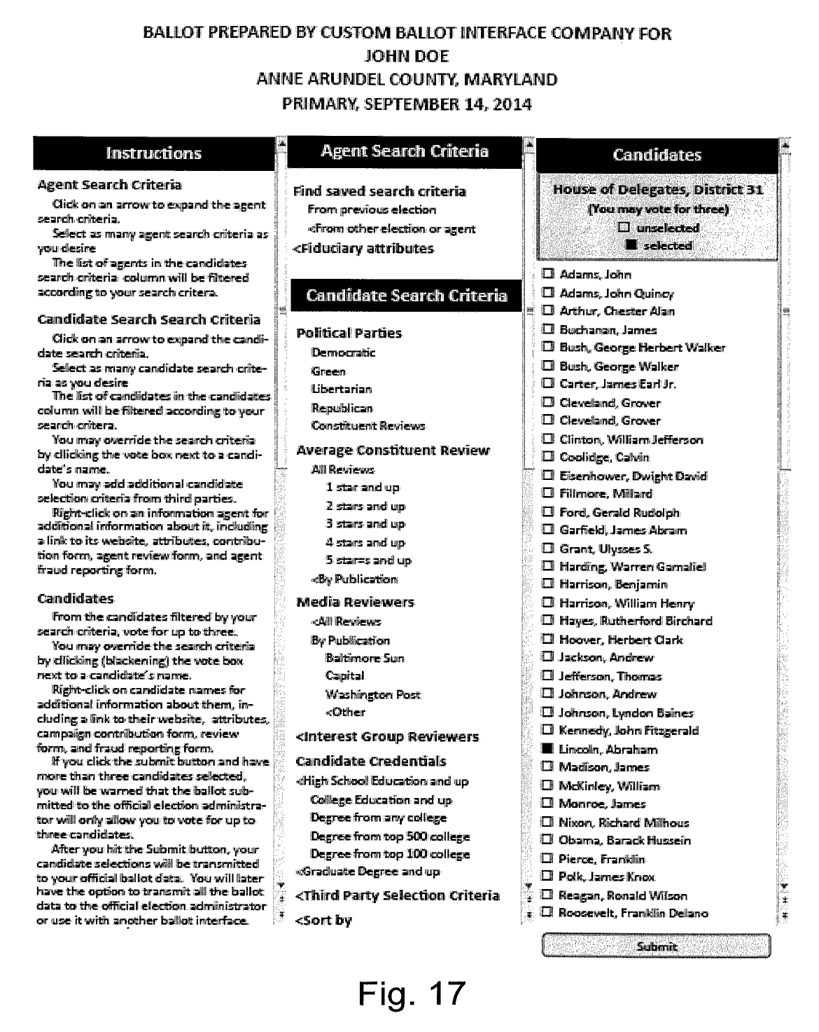

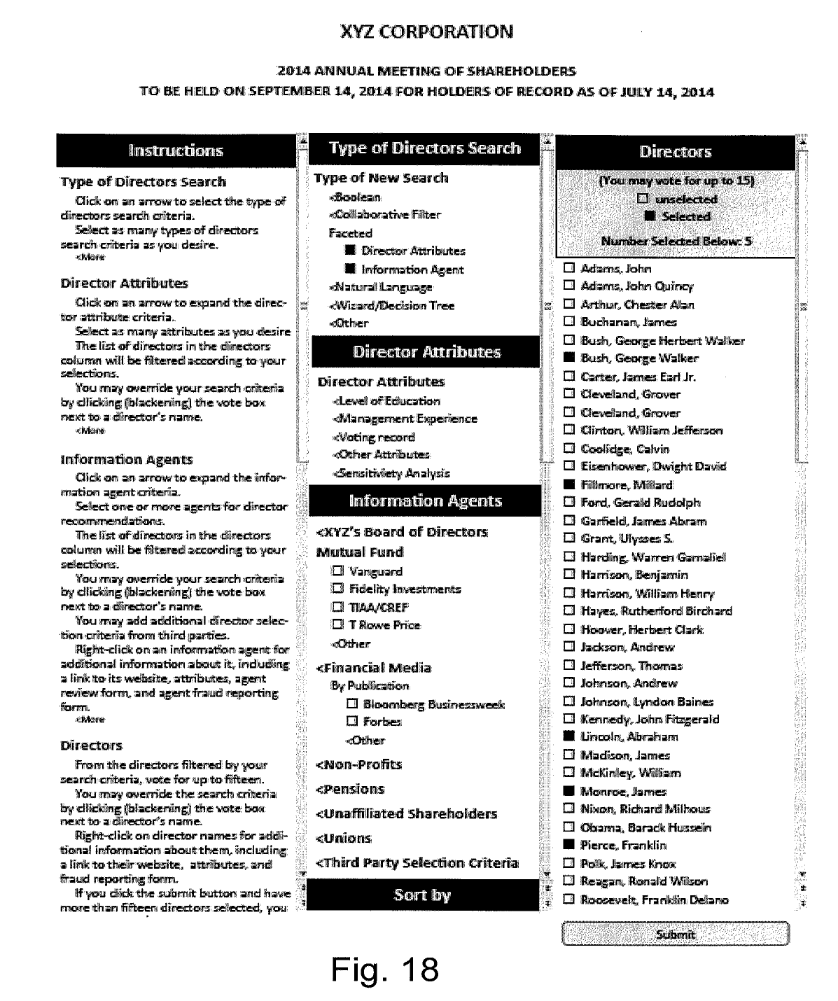

FIG. 16 illustrates a portion of an electronic ballot created in accordance with some embodiments of the invention. The electronic ballot may include a selection of one or more offices or issues with which a voter may interact to vote for a selected office. In the example of FIG. 16, the offices and issues are political, although it should be appreciated that the ballot items may alternatively be corporate offices or issues in a corporate election, as embodiments of the invention are not limited in this respect. After a voter selects one of the offices or issues listed on the ballot, a user interface displaying the ballot may be configured to display a ballot interface that enables the voter to vote for on the ballot item. Examples of such ballot interfaces for a political election and a corporate election are shown in FIGS. 17 and 18, respectively.

FIG. 17 illustrates a portion of an exemplary electronic ballot prepared in accordance with a ballot interface of an information agent on behalf of a voter. The ballot may include a plurality of sections with which the user may interact to search and filter the data. For example, the listing of candidates may be filtered and displayed based on political party affiliation, reviews by media or interest groups, a candidate's credentials, or any other criteria specified on the ballot interface. Based on search criteria entered by a voter, one or more candidates representing the search criteria may be automatically selected and displayed on the ballot interface. The iterative process of selecting voting choices may be repeated until the voter is satisfied with the voting choices. The voter may then interact with a voting submission selector to transmit the votes to an election administrator to vote, as described above.

Searching and filtering ballot data based on a voter's interaction with a ballot created in accordance with embodiments may occur in any suitable way depending on the particular type of ballot interface that is used, as aspects of the invention are not limited in this respect. For example, rather than using a faceted search, as was previously described with regard to FIG. 17, other types of search interfaces may also be used including, but not limited to, Boolean, natural language, wizard/decision trees, and collaborative filters. An exemplary corporate ballot incorporating at least some of these alternate types of search interfaces is illustrated in FIG. 18.

Corporate ballot interfaces may be similar to political ballot interfaces in some respects and different in other respects, as aspects of the invention are not limited in the type and/or functionality of the particular ballot interface that is integrated with ballot data. For example, the secrete ballot may be less important in corporate elections than in political elections, as illustrated by the U.S. Securities and Exchange Commission (SEC) requirement that mutual funds, pensions, and others voting on behalf of individual shareholders may need to publicly disclose how they voted. To facilitate this disclosure of information, some corporate ballot interfaces may be configured to provide voting information directly or indirectly to one or more third party regulatory bodies such as the SEC. Additionally, corporate elections may allow proxy voting, whereby for example, a shareholder may designate an agent to vote on his behalf at the annual meeting of a corporation. Accordingly, some corporate ballot interfaces could be integrated with ballot data to create a proxy ballot that enables an agent to cast votes in a corporate election on behalf of a shareholder.

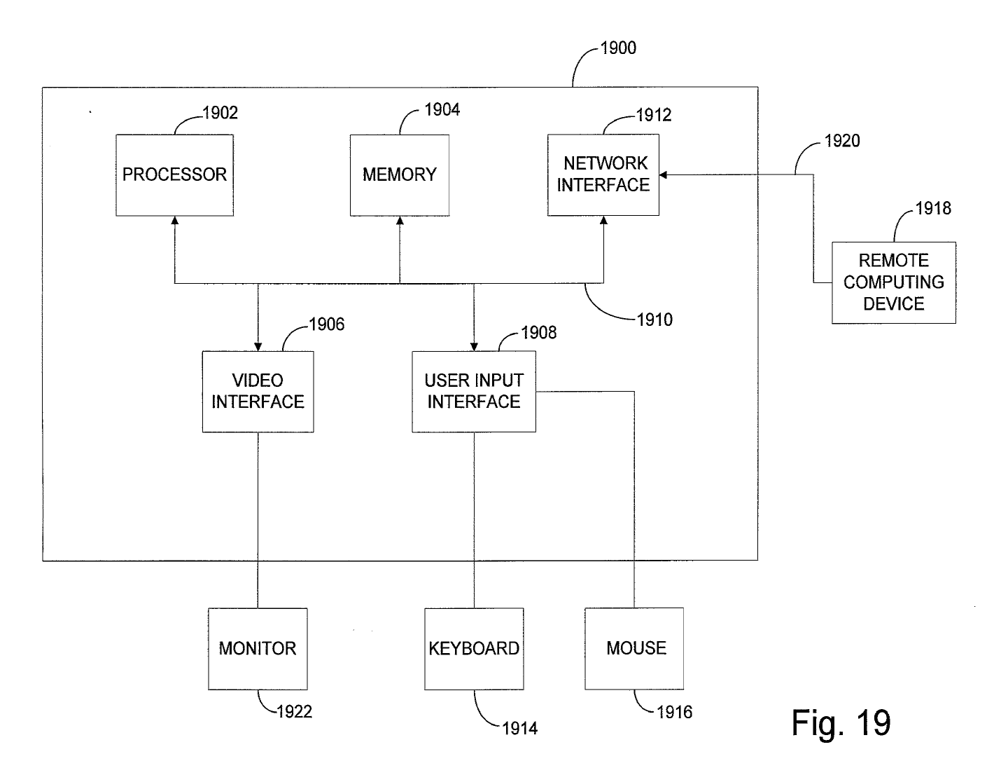

FIG. 19 shows a schematic block diagram of an illustrative computer 1900 on which aspects of the invention may be implemented. Only illustrative portions of the computer 1900 are identified for purposes of clarity and not to limit aspects of the invention in any way. For example, the computer 1900 may include one or more additional volatile or non-volatile memories, one or more additional processors, any other user input devices, and any suitable software or other instructions that may be executed by the computer 1900 so as to perform the function described herein.

In the illustrative embodiment, the computer 1900 includes a system bus 1910, to allow communication between a central processing unit 1902, a memory 1904, a video interface 1906, a user input interface 1908, and a network interface 1912. The network interface 1912 may be connected via network connection 1920 to at least one remote computing device 1918. Peripherals such as a monitor 1922, a keyboard 1914, and a mouse 1916, in addition to other user input/output devices may also be included in the computer system, as the invention is not limited in this respect.

In some embodiments, one or more techniques described herein may be performed by one or more processors included in the same or different computer including, but not limited to, computer 1900. In embodiments where multiple processors are used, the results of one technique performed by a first processor may be transmitted to a second processor to perform a second technique in any suitable way including, but not limited to, transmitting the results across a wired or wireless network, storing the results in a shared database, and physically transferring the results to a second computer on a tangible computer-readable medium.

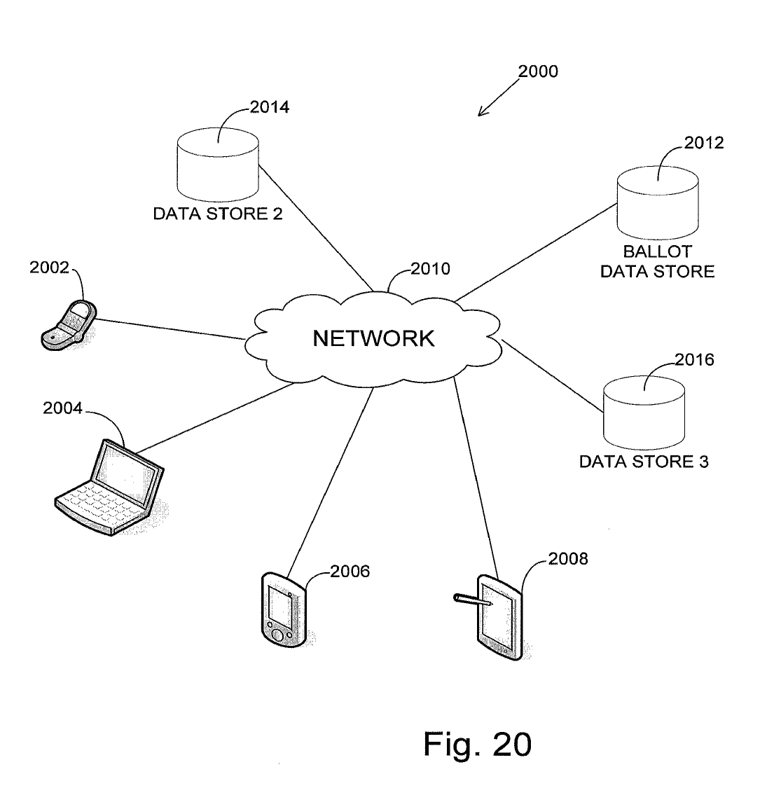

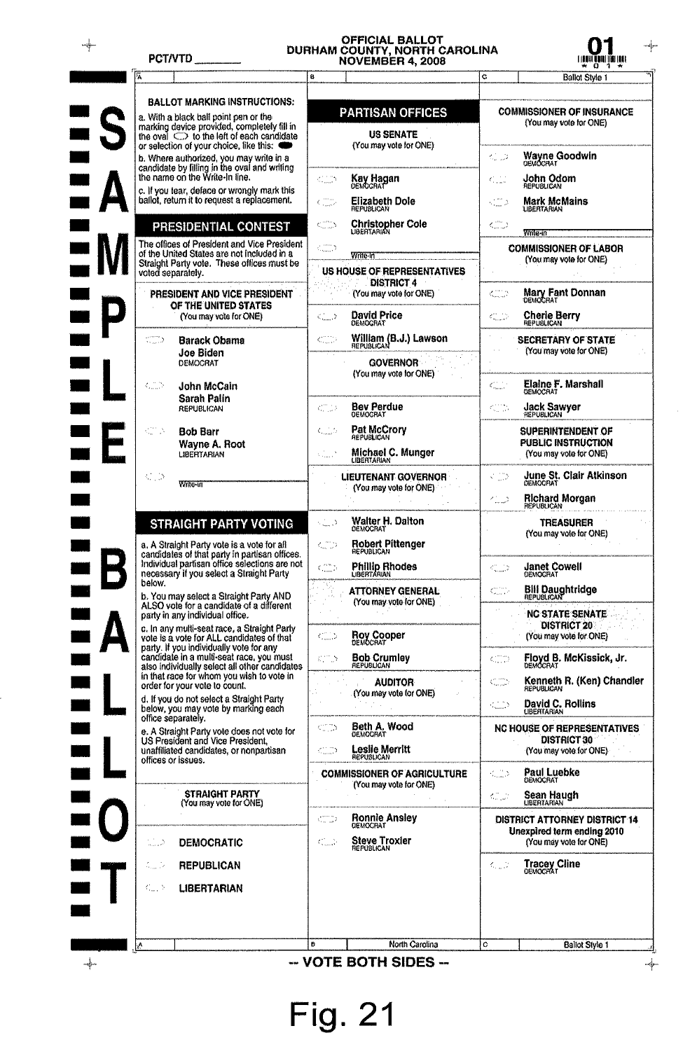

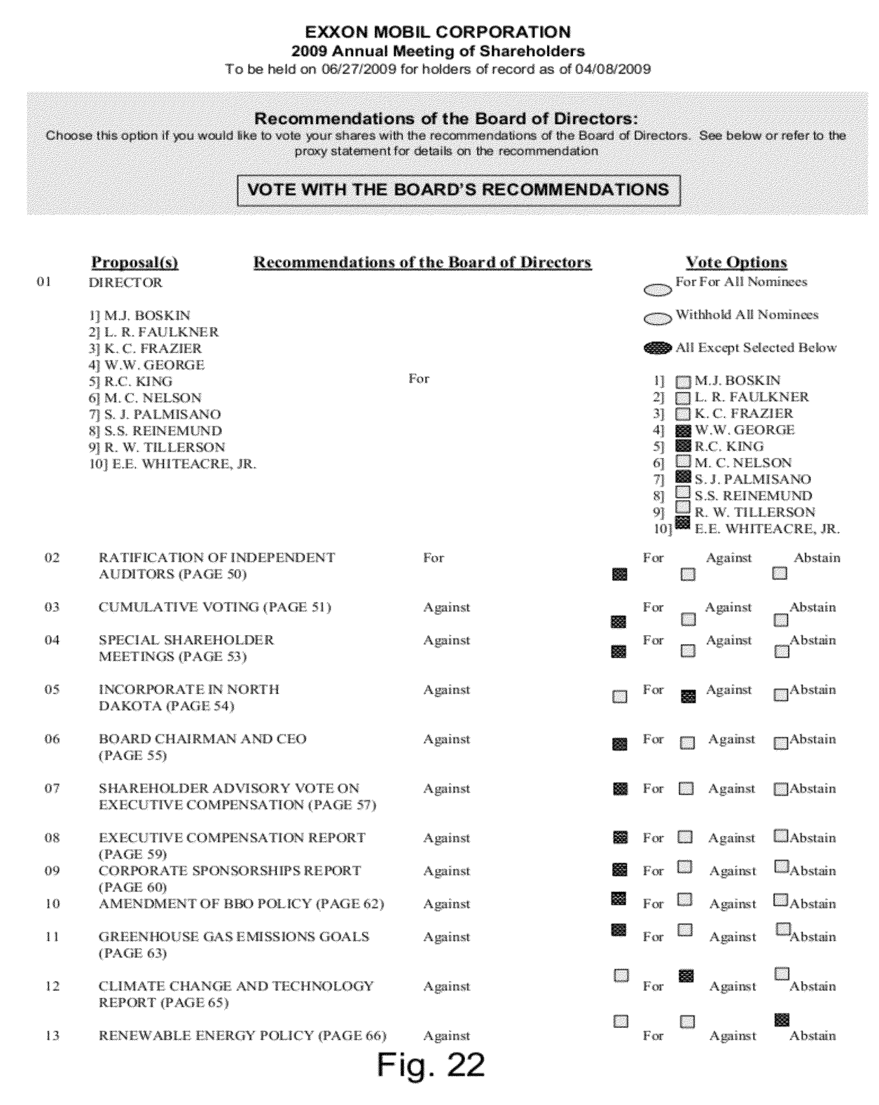

Some embodiments may be used in connection with at least one networked computer system such as the computer system 2000 illustrated in FIG. 20. The computer system 2000 comprises a plurality of computing devices including, but not limited to cellular phone 2002, laptop 2004, PDA 2006, and tablet computer 2008. Each of these computing devices is connected to a plurality of data sets via network 2010 using one or more wired or wireless connections. For example, network 2010 may be the Internet and each of the computing devices may comprise software and/or hardware configured to access the Internet using one or more wired or wireless connections. The computer system 2000 may include a plurality of data stores accessible to network 2010 and configured to store data sets comprising election and/or ballot data stored in accordance with an election and/or ballot ontology as described herein. In some embodiments, the plurality of data stores includes at least one ballot data store 2012 configured to store ballot data prepared by an election administrator. The plurality of data stores may also include data stores (e.g., data store 2014 and data store 2016) configured to store other information related to election data or interfaces or ballot data or interfaces. Embodiments are not limited by the number of data stores and computing devices in computer system 2000. For example, in some embodiments, all computing devices and data stores connected to the Internet may be considered as part of computer system 2000.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of providing a configurable electronic ballot for an election, the method comprising:
specifying a ballot interface that defines a format for presenting ballot data to a voter;
sending, via at least one network, a request for the ballot data, wherein at least one datum in the ballot data is associated with at least one machine-readable tag that identifies a meaning of the at least one datum;
receiving the ballot data in response to the request; and
integrating the ballot data with the ballot interface based, at least in part, on the at least one machine-readable tag to generate the configurable electronic ballot for the election.

2. The method of claim 1, wherein integrating the ballot data with the ballot interface comprises:
displaying on the configurable electronic ballot the meaning for the at least datum in the ballot data based, at least in part, on the format defined by the ballot interface.

3. The method of claim 1, further comprising:
specifying an election interface that includes the ballot interface.

4. The method of claim 3, wherein specifying the ballot interface comprises receiving an indication that the ballot interface has been selected from the election interface.

5. The method of claim 3, wherein the election interface includes at least one form for voter registration.

6. The method of claim 1, further comprising:
presenting the configurable electronic ballot to a voter;
receiving input from the voter indicating voting information for the configurable ballot; and
sending the voting information to a centralized election administrator.

7. The method of claim 6, wherein sending the voting information comprises:
automatically uploading the voting information to a computer hosted by the centralized election administrator.

8. The method of claim 1, further comprising:
displaying to a voter a plurality of independent information agents;
receiving input from the voter indicating a selection of one of the independent information agents;
specifying the ballot interface based, at least in part, on the selection of one of the independent information agents.

9. The method of claim 8, wherein sending the request comprises automatically downloading the ballot data in response to receiving the input from the voter indicating a selection of one of the independent information agents.

10. The method of claim 1, wherein integrating the ballot data with the ballot interface comprises:
modifying at least one aspect of the configurable electronic ballot in response to an input from a voter.

11. The method of claim 10, wherein modifying at least one aspect comprises:
filtering and/or sorting voting options displayed on the configurable electronic ballot.

12. The method of claim 10, wherein modifying at least one aspect comprises displaying information, voting preferences, and/or voting recommendations on the configurable electronic ballot.

13. The method of claim 12, further comprising:
automatically selecting voting information for the configurable electronic ballot based, at least in part, on the displayed information, voting preferences, and/or voting recommendations; and
displaying the selected voting information to the voter.

14. The method of claim 13, further comprising:
sending the voting information to a centralized election administrator.

15. The method of claim 10, further comprising:
modifying the at least one aspect of the configurable electronic ballot based, at least in part on the at least one voting preference for a voter.

16. The method of claim 15, wherein modifying the at least one aspect of the configurable electronic ballot comprises:
indicating to the voter a voting recommendation based, at least in part, on the at least one voting preference.

17. The method of claim 1, further comprising:
receiving input from a voter indicating contribution information for at least one independent information agent and/or at least one candidate on the configurable electronic ballot; and
associating the contribution information with the at least one independent information agent and/or the at least one candidate.

18. The method of claim 1, further comprising:
receiving geographical information from a voter;
wherein a content of the ballot data is determined based, at least in part, on the geographical information.

19. The method of claim 18, wherein the geographical information is a home address of the voter.

20. The method of claim 1, wherein the election is a corporate election.

21. The method of claim 21, wherein the configurable electronic ballot is a proxy ballot that enables an agent to vote on behalf of a shareholder in a corporation.

22. The method of claim 1, wherein the ballot interface and the ballot data are specified by a centralized election administrator.

23. The method of claim 22, wherein the centralized election administrator is a government official.

24. The method of claim 1, wherein the ballot interface is specified by an independent information agent and the ballot data is specified by a centralized electron administrator.

25. The method of claim 24, wherein the independent information agent is a political party, an interest group, and/or a media outlet and the centralized election administrator is a government official.

26. A computer-readable storage medium encoded with a plurality of instructions that, when executed by a computer, perform a method comprising:
specifying a ballot interface that defines a format for presenting ballot data to a voter;
sending, via at least one network, a request for the ballot data, wherein at least one datum in the ballot data is associated with at least one machine-readable tag that identifies a meaning of the at least one datum;
receiving the ballot data in response to the request; and
integrating the ballot data with the ballot interface based, at least in part, on the at least one machine-readable tag to generate the configurable electronic ballot for the election.

27. A computer system including a first computer and a second computer connected via at least one communication medium, the second computer comprising:
at least one processor programmed to:
specify a ballot interface that defines a format for presenting ballot data to a voter;
send via at least one network, a request for the ballot data, wherein at least one datum in the ballot data is associated with at least one machine-readable tag that identifies a meaning of the at least one datum;
receive the ballot data in response to the request; and
integrate the ballot data with the ballot interface based, at least in part, on the at least one machine-readable tag to generate the configurable electronic ballot for the election.
